(19) United States
(12) Patent Application Publication
(10) Pub. No.: US 2026/0280995 A1
(43) Pub. Date: Sep. 17, 2026

(54) SYSTEM AND METHOD FOR OPERATING A DIGITAL TWIN OF A COMMUNICATIONS SYSTEM

(71) Applicant: Kabushiki Kaisha Toshiba, Tokyo (JP)

(72) Inventors: Peizheng LI, Bristol (GB); Adnan AIJAZ, Bristol (GB)

(73) Assignee: Kabushiki Kaisha Toshiba, Tokyo (JP)

(21) Appl. No.: 19/076,586

(22) Filed: Mar. 11, 2025

(51) Int. Cl. H04L 41/14; H04L 41/0894; H04L 41/16

(52) U.S. Cl. CPC H04L 41/145; H04L 41/0894; H04L 41/16

(57) ABSTRACT

Provided is a method performed by a computer system, the computer system serving as a host in a communications system and comprising a simulation engine, the method comprising: receiving, from the communications system, operational information related to the communications system; generating, using the operational information, a digital twin, the digital twin representative of the communications system; receiving, from the communications system, network traffic data; and simulating, using the digital twin and the network traffic data, one or more behaviours of the communications system.

### FIELD

Embodiments described herein relate to systems and methods for generating and implementing a native digital twin of a communications system.

### BACKGROUND

Formally introduced in the early 2000s, digital twins have since played a crucial role in various fields, including industry, healthcare, and smart cities. A digital twin acts as a digital representation of a physical object or assembly, facilitating low-cost algorithm development, prototype verification, and innovation across diverse domains.

In the realm of telecommunications, the advent of wireless communication systems has brought forth complex deployment scenarios and stringent performance requirements. Challenges include quality of service improvement, network coverage optimization, resource allocation, traffic steering, and routing path selection. Integrating digital twins with 4G/5G/6G technology enables real-time network monitoring, predictive maintenance, and scenario analysis, offering possibilities for intelligent and adaptive network management and advancing communication infrastructures.

Current engineering practice often limits digital twins to external simulators, hindering proactive interaction with the wireless communication system for realistic, near-real-time optimization.

### BRIEF DESCRIPTION OF THE DRAWINGS

Embodiments will now be described by way of example with reference to the accompanying drawings in which:

FIG. 1 shows digital twin functionalities in the context of a communications system.

FIG. 2 shows conventional example interactions between a real-world network and its digital twin.

FIG. 3 shows a proposed digital twin architecture in accordance with embodiments.

FIG. 4 shows a process diagram for carrying out AI and machine learning processes in the digital twin.

FIG. 5 shows the extraction of a timestamp, user equipment ID and event marker from the real data stream.

FIG. 6 shows a flowchart of a digital twin fidelity self-improvement method.

FIG. 7 shows a deployment of an in-network digital twin.

FIG. 8 shows an implementation of the digital twin in a 5G network.

FIG. 9 shows features of the digital twin implementation in a 5G network.

FIG. 10 shows the architecture of an Open RAN system.

FIG. 11 shows a workflow for anomaly detection implementation in a digital twin.

FIG. 12 shows how the digital twin anomaly detection functions for 5G Open RAN.

FIG. 13 shows how a digital twin scheduling simulation functions for 5G Open RAN.

FIG. 14 shows a conceptual illustration of the interaction of different functions in the digital twin for network state monitoring.

FIG. 15 shows an example use case of anomaly classification in the digital twin using real-world UE measurements.

FIG. 16 shows a visualisation of t-SNE analysis on the neural network outputs from FIG. 15.

FIG. 17 shows an example of the digital twin’s function coordination and cooperation in the Open RAN for connectivity management.

### DETAILED DESCRIPTION

According to a first embodiment, there is provided a method performed by a computer system, the computer system serving as a host in a communications system and comprising a simulation engine, the method comprising:

receiving, from the communications system, operational information related to the communications system;

generating, using the operational information, a digital twin, the digital twin representative of the communications system;

receiving, from the communications system, network traffic data; and

simulating, using the digital twin and the network traffic data, one or more behaviours of the communications system.

The method may further comprise making, based on the simulated behaviour, an adjustment to an operating parameter of the network

The operating parameter may comprises one of the following: a resource allocation of the network; a policy of the network; or a configuration of the network.

The computer system may comprise an anomaly detection module, the anomaly detection module comprising a neural network; and simulating one or more behaviours of the communications system may comprise: inputting the network traffic data into the neural network; and determining, by the neural network, a classification of the behaviour of the network.

Determining the classification may comprise classifying the behaviour as anomalous.

The network traffic data may comprise measurements taken by a user device; and the behaviour of the network may comprise a connection status of the user device.

The method may further comprise, responsive to classifying the behaviour as anomalous, changing a connection used by the user device.

The digital twin may comprise a scheduling module, and simulating one or more behaviours of the communications system may comprise simulating a throughput of the communications system in accordance with a particular traffic schedule.

The adjustment to the operating parameter of the network may comprise an adjustment to a traffic schedule of the network.

The digital twin may comprise a synthetic data generation module, and the method may further comprise: receiving, from the synthetic data generation module, synthetic network traffic data; wherein the synthetic network traffic data is additionally used alongside the digital twin and the network traffic data to simulate one or more behaviours of the communications system.

The method may further comprise: defining, in each element of the synthetic network traffic data, a synthetic timestamp; embedding, by a user device, a timestamp into a resource block of each element of the network traffic data; and integrating, using the timestamps and the synthetic timestamps, the synthetic network traffic data into the network traffic data.

The method may further comprise using a high-frequency clock synchronization protocol to match a clock speed of the digital twin with a clock speed of the communications system.

The method may further comprise using a time analytic function to identify a time difference between the communications system and the digital twin, and applying a correction to the digital twin.

The digital twin may comprise a machine learning module, and the method may further comprise: training, by the machine learning module, a machine-learning model on the operational information and network traffic data; and deploying the trained machine-learning model in the communication network.

The digital twin may comprise a synthetic data generation module, and the method may further comprise: receiving, from the synthetic data generation module, synthetic network traffic data; and training, by the machine learning module, the machine-learning model on the synthetic network traffic data.

The method may further comprise: receiving, from a user, a request to update the digital twin, the request comprising an indication of a characteristic of the digital twin to update, wherein the characteristic comprises at least one of:

a characteristic of the communications system modelled by the digital twin;

a method of driving the simulation; and

a modelling parameter of the digital twin; and updating the characteristic of the digital twin.

The computer system may be a distributed computer system.

The communications system may be an Open RAN network, and the digital twin may be comprised within the RIC of the Open RAN network.

According to another embodiment there is provided a system, the system comprising:

a host platform, the host platform connected to a communication system and comprising:

a simulation engine, the simulation engine suitable for executing a simulation; and

computing hardware, the computing hardware suitable for running the simulation engine; and

a digital twin, the digital twin modelling the communication system and maintained by the simulation engine;

wherein the digital twin utilises operational information received from the communication system to improve the accuracy of the digital twin.

For wireless communication system digital twin design, it is advantageous to tightly couple the digital twin with the real network, ensuring an accurate reflection of the real-world entity. This involves open interfaces for flexible platform construction, secured data exchange, support for artificial intelligence (AI)/machine learning (ML) models, and constant self-correction based on real-world and synthetic data.

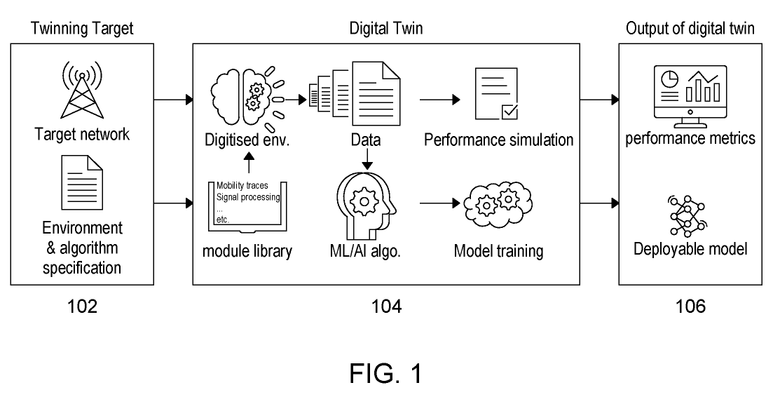

FIG. 1 shows the functionalities, modules, and workflow of a known digital twin in the context of the communication system, which has been widely recognised by the research community and industry. In specific, the major units and functions of the digital twin are shown in the central box of FIG. 1, wherein the digitized environment plays a central role. The digitized environment is generally the approximation of the physical entity in the real world designated as the twinning target, using computer programs and mathematical models. It is able to generate the required emulated data by leveraging a rich set of third-party libraries.

The generated data can be used for the potential performance simulation. Alternatively, or additionally, the generated data can be fed into the AI/ML models for further training and validation of said models. In this case, the digital twin is working as an external simulator of the twinning target (for example a 4G, 5G or 6G network), performing simulations of the network according to different environments and algorithm settings, and generating the corresponding outcomes. In some cases, possible outcomes include a performance dashboard, indicating metrics of the network, such as the throughput, signal strength, and coverage of the network, or one or more deployable ML models for wireless network control and optimisation. In some cases, this digital twin framework can accept real data from wireless networks, for the purpose of network monitoring or diagnosis.

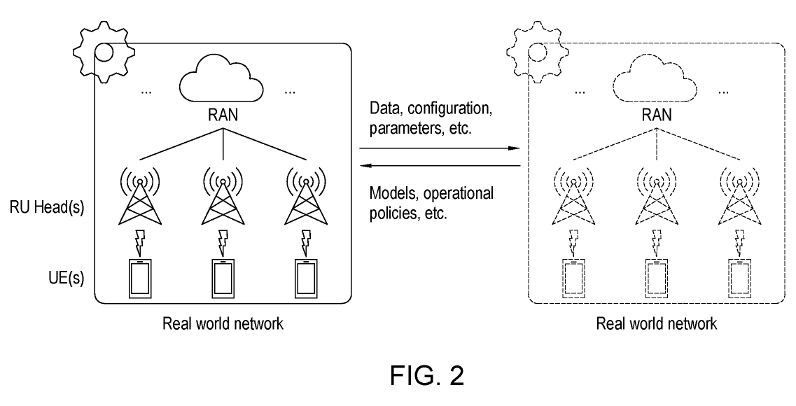

An illustration of an interaction between the real-world communication system and the network digital twin is depicted in FIG. 2. In the real communication network, the units of user equipment (UEs) are attached to the radio unit (RU) heads and corresponding radio access network (RAN) for the potential voice call, message and network data service. Correspondingly, the digital twin is a dedicated virtual copy of the network, encompassing the UE, RU and RAN elements, as well as the links among these elements.

The known digital twin framework works outside of the network as an independent simulation engine. In this framework, the computational equipment on which the digital twin is executed has no relationship with the network in question. The digital twin instead works independently in a computer isolated from the network. The digital twin receives information about the network through system setups and configuration parameters, manually input from a user.

In such cases there is instead a causal relationship between digital and the real network, specifically according to the time order. The digital twin takes the network data, configuration, and parameters from the user into consideration for simulation and planning. After completion of the simulation, results of the simulation, such as trained models and network operational policies, are fed manually back to the real network for network orchestration and management. As a result, this digital twin has a loose connection with real-world operating wireless networks in terms of the data/configuration/policy exchange. This means the effectiveness and timeliness of the digital twin in guiding or guaranteeing the operation of the network is limited, especially considering the lengthy and cross-substrate feedback and control loop.

Embodiments provided herein concern an improved implementation of digital twin design. The digital twin envisioned is native to a communications system. As used herein, native refers to the digital twin residing within the communications system, rather than outside of it. As a result of this framework, the in-network digital twin is linked with the subject network more tightly, via connections for accessing the network’s configuration and parameters.

A newly designed digital twin architecture is provided in an embodiment. This digital twin architecture takes the wireless network’s features, interfaces, data flow, and architecture into consideration. The digital twin architecture may take into account one or more of the architecture of a RAN (such as monolithic RAN or Open RAN, for example), the configuration of the network (such as the RAN deployment density and/or the intended coverage, for example), and transport and core network configurations and capabilities. The digital twin of the embodiment is able to be executed as a completed software package with native advanced network function support.

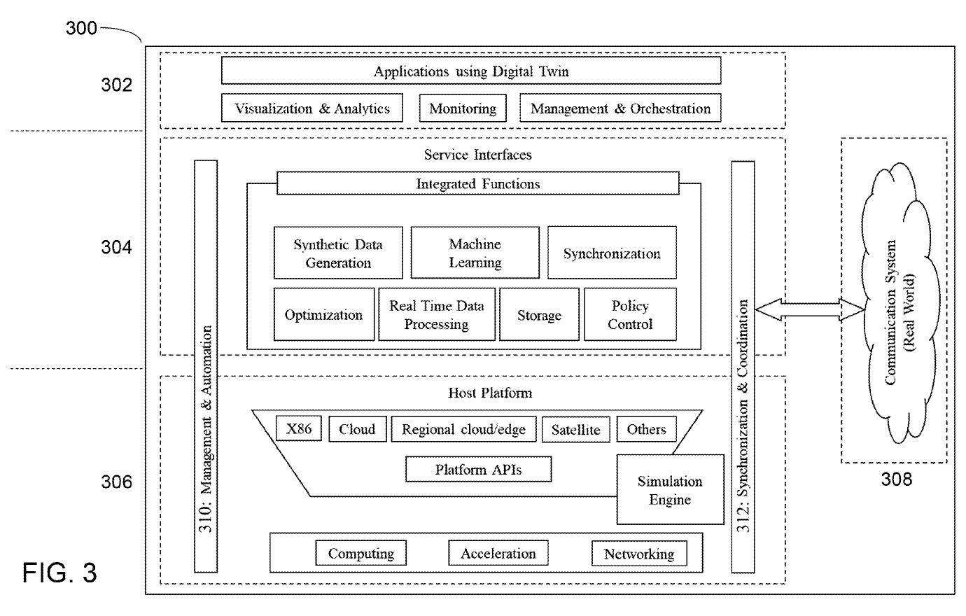

FIG. 3 illustrates an example of a suitable architecture 300 for the in-network digital twin, according to embodiments. This digital twin architecture aims to tightly link the virtual simulation environment and the real communications system, functioning as a platform for coordinating behaviours between the digital twin and the real communications system. The architecture comprises three main components: a host platform 306, a set of integrated functions 304, and applications 302.

The host platform 306 is a computer system connected to the communication system 308. The host platform 306 comprises hardware suitable for hosting a digital twin, such as general-purpose servers like x86 servers, cloud computing servers, regional cloud/edge computing servers, and satellites. In some embodiments, the host platform 306 may comprise a number of physically separate computer systems, such as a distributed computer system. The host platform is accessible to users by platform APIs for access to the digital twin and related applications.

The host platform 306 may be connected to the communication system by a wired connection, such as an Ethernet or Serial connection. Alternatively, the host platform 306 may connect to the communication system via a wireless connection.

The host platform should also have computation, acceleration, and networking capabilities. These capabilities allow the host platform to run the software to execute the required simulation. This software is known as the simulation engine. The simulation engine is operated in a fly (dynamic) fashion, meaning it is able to call different functions 304 for diverse simulation requirements. In a fly (dynamic) simulation engine, functions are called adaptively based on real-time requirements during the simulation, dynamically selecting an appropriate function based on evaluation of the current state of the simulation instead of following a fixed sequence. For example, in a network simulation, if user demand spikes, the engine might dynamically invoke a congestion control algorithm. This makes the system flexible and responsive to variations in conditions. The integrated functions 304 are shown in FIG. 3, and are discussed later.

The digital twin of the communication system 308 is initialised and maintained within the host platform, with the simulation engine being an integral part of the digital twin’s functionality. The integrated functions 304 provide additional capabilities to enhance the overall performance of the digital twin.

Numerous applications 302, also shown in FIG. 3, make use of the digital twin during operation. These applications may include visualization and analytics applications, monitoring applications, and applications controlling the management and orchestration of the real-world system. All applications are supported by service interfaces for access to the digital twin’s integrated functions 304 including functions for synthetic data generation, machine learning, optimization, synchronization, storage, and policy control etc. The applications have the flexibility to select and utilize these functions for diverse purposes. These functions form the foundation of digital twin application operations, and they can be expanded or scaled-up based on operational requirements.

These two sections, integrated functions and the host platform, essentially form the digital twin framework. Moreover, FIG. 3 highlights the cooperation between the host platform and the digital twin on the left and right sides of sections 304 and 306. Firstly, the host platform and digital twin should be managed by a shared automation method 310 to ensure consistency, real-time decision-making, and efficient collaboration and interoperability. Secondly, the host platform and digital twin should be managed by a synchronization and coordination mechanism 312 to ensure alignment and accuracy for the data, decision, and configurations. Such a synchronization and coordination mechanism 312 is discussed below.

The real communication system 308 illustrated in FIG. 3 refers to other communication system components that can’t be integrated in the host platform, such as the UEs and remote radio heads. The interaction between this communications system 308 and the digital twin framework is vital, and such interaction must be bidirectional. On one hand, the communication system needs to pass the operational information, including possible UE measurements, data frame, and/or operational logs to the digital twin for modelling, optimization, and decision making. On the other hand, the outcomes of the digital twin’s applications, such as the digital twin generated models, policies or simulation results, must be implemented by the real network to take effect. The outcomes of the digital twin’s applications may be implemented in the real network by an operator of the network, such as by a system optimization engineer of the operator. Alternatively, the digital twin may have access to automatically implement the outcomes of its applications in the network, to streamline the optimization process.

By running the simulation internally in a host of the network, the effectiveness and timeliness of the digital twin in guiding or guaranteeing the operation of the network is greatly improved. The communication between the communication system and the digital twin during operation of the communication system allows for adaptive guiding and adjustment of network parameters and policies in response to real-time events and data, rather than afterwards, as in the conventional structure described above.

This interaction can take place via dedicated interfaces/APIs. The core principles of the interfaces/APIs are basic CRUD (create, read, update, delete) operations for subsystem/submodel elements of the digital twin and its corresponding targets. These interfaces can be defined with multiple communication protocols. The design of particular interfaces and APIs is not provided in this disclosure, as a wide range of said interfaces may be suitable for performing this task.

In embodiments where the digital twin is natively integrated to an Open RAN system, the E2 interface can be used for such communication. The RAN components including the RU, the DU and the CU can exchange information via RIC subscription. A later example will showcase this functionality of the E2 interface.

As previously mentioned, FIG. 3 illustrates the integrated functions 304 of the digital twin, each of which will now be described in turn.

### Synthetic Data Generation

Synthetic data generation is beneficial in designing a communication system digital twin as it enables the creation of realistic datasets for testing and validating system performance without exposing sensitive information. It provides a controlled environment for exploring diverse scenarios, testing machine learning models, and addressing cost and availability challenges associated with acquiring and maintaining real-world data. Synthetic data allows designers to simulate a wide range of conditions, improving the digital twin's accuracy, privacy, and flexibility, ultimately facilitating effective analysis, optimization, and calibration of the communication system.

The synthetic data may be generated by one or more of mathematical models, which simulate signal behaviours and system dynamics; statistical sampling, which generates data based on real world distributions; generative AI, which uses models such as generative adversarial networks or variational autoencoders to create data similar to real datasets; and scenario simulation, which simulates diverse network conditions to create realistic data.

### Machine Learning

The AI/ML function can be integrated with the digital twin to enable the digital twin to finish the pre-simulations to allow intelligent control of the communication network. Embodiments disclosed herein integrate AI/ML models into the disclosed digital twin. This allows not only use of the digital twin to train an AI/ML model and generate a deployable model, but also takes the holistic AI/ML model pipeline into consideration. Meanwhile, this pipeline can take effect inside of the real network, which is also referred to as the in-network development and deployment of AI/ML models. Also disclosed is a ML model provision and orchestration scheme, which allows tailoring of the model to meet different service requirements.

The disclosed digital twin is a standalone containerized application, running independently and entirely on the host platform 306 without requiring external services and libraries to function. The digital twin is capable of deployment in the cloud, RAN and multi-access edge computing (MEC) devices associated with the target wireless communication systems. This creates an advantage for the AI/ML components in the digital twin, enabling in-network development and deployment. In that sense, the wireless network traffic flow can be fed into the digital twin directly without passing through the external data processing modules outside of the network.

This provides for the following benefits. Firstly, this allows the model to be trained on in-network real-time data, which leads to better performance of the model. Training on in-network real-time data leads to better performance because the model adapts to the current and dynamic conditions of the network, such as traffic patterns, latency, and user behaviour. This allows the model to better capture real-world variations during training and make more accurate predictions or decisions, improving the overall effectiveness and responsiveness of the model when deployed.

Secondly, the model and data do not have to be sent to a central server for training, which reduces latency of the training. Thirdly, by removing the need to transfer data to a central server, the privacy of the data can be maintained. These benefits can be achieved by ensuring the logistic control plane of the digital twin supports data forwarding, extraction and interpretation capability within the specific communication system, for example by implementing data flow control (e.g. rule-based filtering and prioritisation) and real-time data transformation functions within the digital twin logistic plane.

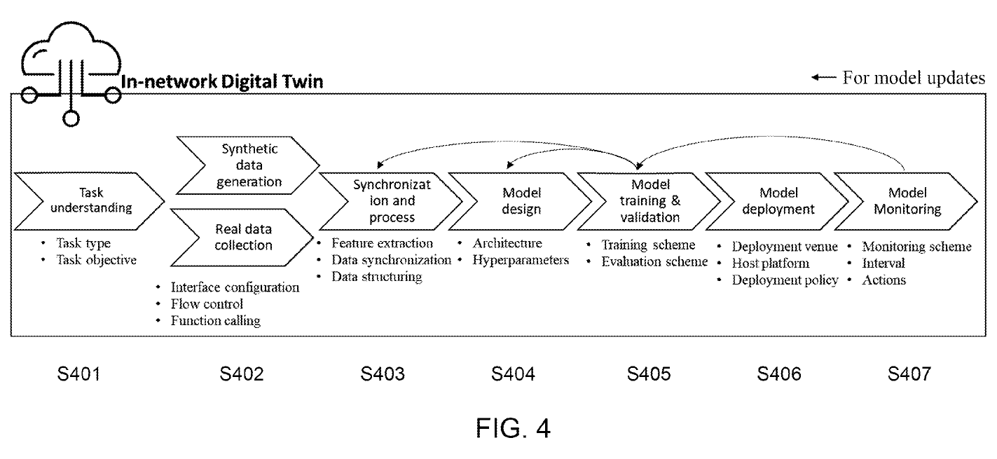

Another benefit afforded by the disclosed structure is the continuous integration and delivery/continuous deployment ability, which is conceptually close to the Developer operations (DevOps) or machine learning operations (MLOps). DevOps aims to shorten the software development lifecycle and provide continuous delivery with high quality. DevOps teams work collaboratively across the entire software lifecycle, from planning and development to deployment and maintenance, while MLOps has more focus on the ML application development and deployment, considering more on the automation of ML training data generation, training process and model generation. This disclosure refers to the concepts of DevOps and MLOps and proposes to apply such AI/ML development automation and continuous integration and delivery/continuous deployment principles into the digital twin framework. This ensures that the in-network communication system digital twin can be enabled with the capability of in-network AI/ML model lifecycle management and update. A method for enabling this is detailed in FIG. 4, which depicts the automation working of the in-network digital twin AI/ML operation. The method proposed in FIG. 4 comprises the following steps.

At step S401, the AI/ML module of the digital twin first understands the task at hand, including the data characteristics and the desired outcome. The AI/ML module analyses data features, identifies patterns, and aligns with the system’s objectives to determine the best approach for the task, e.g. prediction, optimization or detection.

At step S402, the digital twin will call the simulation engine module to generate synthetic data for training. If the real data from the network is required in this procedure, then the corresponding real data collection module will be triggered. This step requires coordination with the host platform, for the underlying interface configuration and flow control to ensure the free data exchange between digital twin and host platform.

In some configurations, the host platform has access to real network data by virtue of its connection to the network, under the assumption that it is a trustworthy component. However, in other configurations, the host platform’s access may involve specific network configurations or permissions, to allow data collection from the required interfaces. This may include port mirroring/forwarding, setting up packet capture tools, or configuring APIs that expose the network data.

Depending on the security policies and architecture in place, the network and host platform may need to be explicitly configured to ensure secure and appropriate data flow. Once the necessary configurations are made, the host platform can capture or receive real network data from the relevant interfaces.

In principle, there are three types of data reaching step S403: (1) real data, (2) synthetic data, and (3) hybrid real/synthetic data. The synchronization of these data categories is important, to make sure that the training data can be organized in an aligned and meaningful manner. A suitable data synchronization method is discussed later. The data then has to be pre-processed and cleaned, by removing outliers and applying rule-based data filtering, to ensure it is in a suitable format for model training. This may include tasks such as data cleaning, data normalization, and feature extraction.

At step S404, the AI/ML module then designs a model architecture that is suitable for the task at hand. This involves selecting the appropriate type of model (e.g., neural network, decision tree, etc.) and determining the number of layers and parameters in the model.

At step S405, the digital twin trains the model on the pre-processed data, by iteratively adjusting the model parameters to minimize a loss function. Following training, at step S406, the trained model is deployed to the real network where it can be used to make predictions on new traffic data.

At step S407, after deployment of the model the digital twin monitors the performance of the deployed model and updates it as needed to ensure that it remains accurate. The digital twin may update the deployed model upon a determination by a model monitoring module that a KPI for the model is lower than a threshold. The model monitoring module may be enhanced to further support the ML models provision and orchestration. The model monitoring module may be empowered with efficient model selection and outcome-driven optimization capability. Based on the priority and scale of the coming service/simulation request, the model monitoring module may be able to select or update the pre-trained models from the catalogue or model repository.

### Synchronization

We return now to the concept of synthetic and real data synchronization and fusion, previously mentioned in step S403 above. Synthetic and real data synchronization and fusion refers to the ability of the digital twin to process and utilise both real data and synthetic data for use in the simulation and in decision making. Synthetic data can be used to simulate scenarios that may be difficult or expensive to replicate in the real world. By synchronizing synthetic and real data, the digital twin can provide a more comprehensive and realistic simulation environment for testing and analysis.

Additionally, synthetic data can help augment real-world data, especially in situations where the available real data is limited. This enhances the diversity of the dataset, which can be beneficial for training machine learning models with the digital twin. AI/ML models integrated into the digital twin can also benefit from a combination of synthetic and real data for training. This helps in creating models that generalize well to real-world conditions. Lastly, the digital twin can utilize both types of data to improve the fidelity of the digital twin. Resource allocation decisions may be made based on the two data types. Several measures are defined to ensure the feasibility and availability of the data fusion procedure, discussed here in turn.

As synthetic data naturally contains controllable timestamps or other event markers for data synchronization, the challenge lies in the identification and synchronization of the real-world data. For the in-network data, i.e. data recorded about operation of the network, synchronization is not a challenge. This is because the in-network data within the real systems often also contains timestamps, such as the network operational logs and UE measurements. The digital twin can process this type of data through the pre-defined standard interfaces within a 5G network. In 5G, precision time protocol (PTP) is often used in the fronthaul and backhaul segments to ensure accurate synchronization between the central unit (CU) and distributed unit (DU) in a cloud-native RAN. The digital twin framework can also access the PTP information for the timing of the in-network data flow. For the synchronization requirements in digital twin applications that do not demand extremely high accuracy, network time protocol (NTP) can also play a role in synchronization. Therefore, as a first measure, an interface for the above-mentioned time and data synchronization is provided in the digital twin for seamless in-network data flow control and capture.

On the other hand, the traffic flow on the radio side is a significant challenge to handle. The UE sends the data to the RAN over the air. To address this challenge, the radio frame architecture is leveraged.

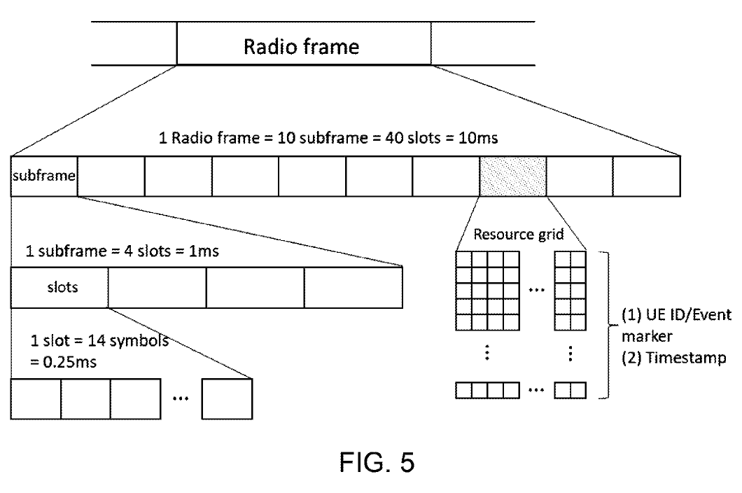

The 5G radio frame structure plays a crucial role in facilitating efficient and high-speed data transmission for various devices and applications. As shown in FIG. 5, the 5G radio frame is organized into a structure that defines the timing and arrangement of different information within a specified time duration. In contrast to previous generations (such as 4G/LTE), 5G introduces a more flexible and adaptable frame structure to accommodate diverse services and requirements. One important feature is the numerology (FIG. 5 shows the configuration of Numerology = 2). 5G supports different numerologies, which represent different subcarrier spacings and slot durations.

This flexibility allows 5G to adapt to various use cases, including enhanced mobile broadband (eMBB), massive machine-type communication (mMTC), and ultra-reliable low-latency communication (URLLC). Another feature is the slot structure, in which the radio frame is divided into slots, and each slot can carry a certain amount of information. The slot structure is designed to support both data and control information, enabling efficient communication between the network and connected devices.

The UE ID, event marker and timestamp can each be embedded in a part of the resource block. A resource block is a unit of allocated resource in the communication system, which is spread in both time and frequency domains. The timestamps or event markers can be embedded by encoding the relevant control data into specific portions of the resource block. The digital twin is then enabled with a resource block decoding function to restore the critical timestamp or event that must be synchronized with synthetic data in digital twin.

As time synchronization for the virtual-real data stream is important, also proposed is a hybrid short-long term synchronization identification scheme. The prerequisites for this scheme include (a) the ability to capture the real-network time and the timestamp in digital twin, and (b) the ability to communication between real network and digital twin. This scheme contains two portions, short-term identification and long-term identification.

Short-term synchronization identification can be implemented to minimize immediate time discrepancies, by using a high-frequency clock synchronization protocol (e.g., NTP) for fine-grained alignment of clocks between the real and digital twin networks. According to the basis clock, we can adjust the simulation clock speed dynamically to match the real-time clock speed, minimizing short-term time drift. Whenever a significant event occurs in the real network (e.g., a configuration change or state change etc.), it needs to notify the digital twin via an event-triggered message sent through the communication layer of the network. This message may contain details such as the event type, timestamp, and relevant data. Any suitable protocol, such as MQTT, REST API, or a message bus, may be used to transmit the message. Upon receiving event notifications, the digital twin state will be updated in real-time to reflect changes in the physical system.

Long-term synchronization identification will be implemented periodically to correct any accumulated time drift. A time analytic function will be conducted to identify the time difference between the real and simulated systems over time, and correspondingly adjust the simulation clock speed or introduce time scaling factors to maintain alignment. The time analytic function continuously measures, analyses, and corrects a time difference between the real-world system and the digital twin, via direct timestamp comparison, or trend comparison of the time difference evolution over time.

Meanwhile, this scheme will monitor and analyse the synchronization performance to continuously improve the hybrid time synchronization system. This improvement takes place through a feedback loop that involves continuous performance monitoring and analysis of time drift patterns. This can be performed using machine learning or adaptive synchronization algorithms.

### Optimization

The optimization function in the digital twin is useful for enhancing the system's efficiency and performance. It employs mathematical algorithms and simulations to iteratively refine system parameters, configurations, or resource allocations. By analysing synthetic or real-world data within the digital twin, the optimization function identifies the optimal settings and configuration of the communications system to maximize throughput, minimize latency, or achieve other specified objectives. This process enables designers to fine-tune the communication system, considering various constraints and scenarios, ultimately leading to improved resource utilization, reduced operational costs, and enhanced overall system effectiveness.

The optimization process may involve defining an objective function for optimization, monitoring the relevant metrics and performance, using an appropriate optimization algorithm such as a gradient-based method, reinforcement learning, or linear/nonlinear programming, and exploring and evaluating configurations to determine an optimal configuration for the system.

### Policy Control

The policy control function in the digital twin is beneficial for managing and enforcing policies that dictate how the system behaves in different scenarios. This functionality involves defining rules and regulations governing aspects such as network access, traffic prioritization, and quality of service. The policy control function ensures that the digital twin accurately reflects the policies implemented in the actual communication system, allowing designers to simulate and analyse the impact of policy changes on system performance. This function often works in conjunction with the above machine learning and optimization functions.

### Real Time Data Processing and Storage

Data storage and real time data processing capabilities are important components of the proposed digital twin’s architecture. These capabilities enable optimal performance of the other functions of the digital twin, such as the high-fidelity modelling, AI/ML models, and synthetic and real data synchronization and fusion, as discussed above. Data storage allows the network digital twin to capture and store real-time data from networks and other sources such as IoT devices and sensors, user equipment, and mobile edge computing data, and storing historical data allows for trend analysis, performance evaluation, and identification of patterns over time.

To establish a sufficient data storing and processing process, four measures are described. These are (1) secured data storage; (2) cross host platform data processing; (3) in-network data functioning; and (4) knowledge distillation, to be discussed in turn.

Securing data in a communication network and ensuring its safe passage to a digital twin involves implementing a robust security framework. Due to the in-network deployment property of the disclosed digital twin, the security concerns in the process of data exchange between the digital twin and network, and data storage are relatively low. From the perspective of design principles, proposed are the following features for secured data storage. Firstly, the implementation of end-to-end encryption to protect data when it travels across digital twin and network; introducing the authentication mechanisms for the data transmission; encrypting data stored in the digital twin and any associated databases; if the digital twin interfaces with other systems through APIs, ensuring that these APIs are secured using authentication and authorization mechanisms, and using secure API gateways to manage and monitor API traffic; and finally performing regular security audits and updates.

To fulfil the digital twin’s functionalities in AI/ML, resource allocation, and orchestration, the network digital twin should have cross host platform processing capability, such that the digital twin’s functions are not limited to a single server or data centre. Instead, the functions can be distributed across multiple host platforms. In that sense, the involved host platforms should provide interfaces for the digital twin, for the purpose of data parsing. In this process, the security measures discussed in the previous section can be utilized.

The primary objective of the disclosed digital twin framework is to be deployed in the network and take effect in the network. The primary functions of the digital twin include network monitoring, neural network (NN) training, and anomaly classification, helping to identify and address potential issues in the network by analysing data and detecting abnormal behaviour.

Data functioning within the digital twin needs a well-orchestrated process, commencing with real-time data ingestion from diverse sources such as network devices, user terminals, and sensors. This data, representative of network topology, device configurations, and traffic patterns, is stored in a meticulously designed data model within databases, facilitating efficient retrieval and analysis. Real-time and batch processing mechanisms handle data dynamically, with streaming analytics managing the influx of live information, while batch processing caters to historical and large-scale analytics. In this way, the digital twin ensures data normalization, standardization, and aggregation, fostering consistency and analytical depth. Security measures, encompassing access controls and anonymization techniques, safeguard sensitive information and promote user privacy. Interoperability is achieved through integration points and adherence to industry standards, facilitating seamless interaction with external systems. Monitoring tools and analytics capabilities provide insight into the digital twin's health and performance, while scalability measures and performance optimization strategies ensure adaptability to the evolving demands of the network ecosystem. Finally, knowledge distillation, defined as the process of extracting the semantic or the most meaningful information from a large amount of raw data in the network, is another innovative feature introduced in this digital twin framework. The extracted data/information will facilitate the AI/ML model's training, decision-making, and resource allocation of the digital twin. Potentially, this procedure can be realized by data compression techniques, such as autoencoding and use of knowledge graphs and information bottleneck methods.

The above functions help to create an accurate digital twin for modelling of the real communication network. Additionally, further disclosed are two measures that assist with the high-fidelity modelling. That is firstly, the fidelity self-improving with feedback, and secondly, cloud-based or distributed simulations and granularity control.

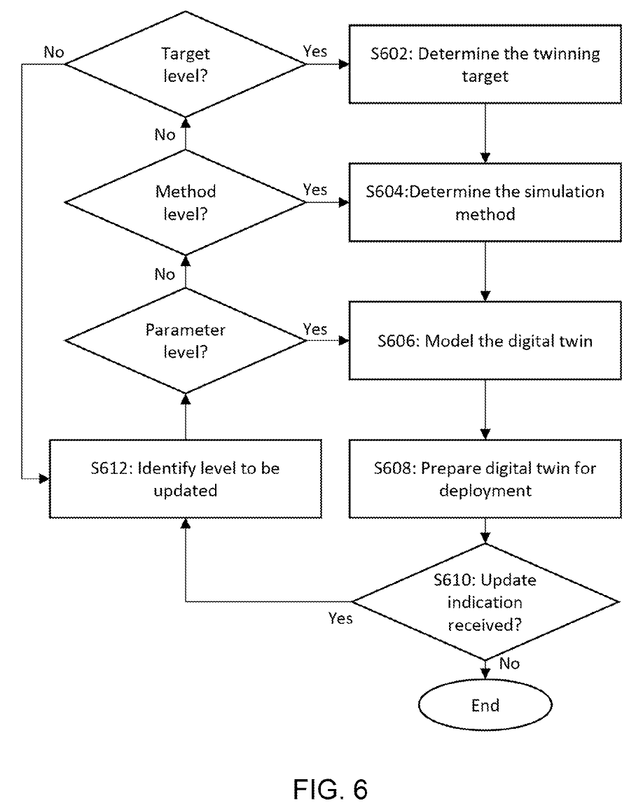

Disclosed is a 3-level digital twin tuning strategy, which is illustrated in FIG. 6, for the self-improvement of the digital twin fidelity. The details of this process diagram is explained below.

At step S602, the digital twin is prepared using knowledge of the twinning target, such as the network protocol, geographic location, RAN types, service requests, and mobility/access scenarios.

At step S604, the simulation method should be determined to match the simulation requirements. For instance, in an event-driven simulation, the simulation progresses in response to events that occur in the communication system. An event is typically an occurrence that changes the state of the system and may trigger specific actions or behaviours, which is well-suited for systems with irregular and unpredictable occurrences such as RAN systems. On the other hand, in a time-driven simulation, the simulation advances at regular intervals of time. The simulation model is updated at fixed time intervals, and the state of the system is computed at each time step. It is well-suited for wireless communication systems that exhibit continuous and smooth behaviours, and it is usually easier to implement in systems where changes are primarily time dependent.

At step S606, this digital twin is modelled with empirical or classical 3GPP models as the backbone, and operational logs as the supplementary. It should also facilitate the possibility of updates according to user feedback after deployment. Then, at step S608, the digital twin is wrapped up as a standalone application or Docker image for potential multi-purpose deployment.

At step S610, an indication as to whether the digital twin should be updated is given by an end user of the digital twin. This indication can be provided by a user interaction through a graphical user interface or dashboard or command line interface. More instructional information regarding the updating level should be given jointly with this indicator, to identify the level to be updated at step S612. There are three levels listed in this figure, to match the key steps in the digital twin forward development process. The first level is when the parameter level of updating is triggered, such as the wireless channel modelling parameters. The corresponding models adopted in digital twin will be updated. The second level is that when the simulation method needs to be updated, and correspondingly an update on the digital twin side will be implemented in the simulation method. Similarly, the third level updating is about the twinning target. For example, when the scale of the target network increases, the existing digital twin has to be upgraded to fit the new network size. It should be noted that these three levels don’t have to be conducted in a time sequence, which means digital twin updates can be triggered simultaneously.

Cloud-based or distributed simulations indicate an important aspect of the proposed digital twin framework. That is, the digital twin should not be limited to the specific venues for simulation. In contrast, it should be flexible enough to be deployed in any computational host such as the cloud or distributed devices. For instance, it could be deployed in the core network, RAN, cloud edge devices or a satellite associated with the wireless communication system, for different system simulation or monitoring requirements.

On the other hand, the simulation granularity control function also plays an important role in this digital twin framework. There is a trade-off between the digital twin granularity and the simulation time/accuracy. This digital twin framework is intended to provide a proactive granularity control option for the digital twin users. By dynamically adjusting the level of detail in the simulation based on real-time conditions, system requirements, and user preferences, a balance between simulation accuracy, computation time and resource utilisation can be found.

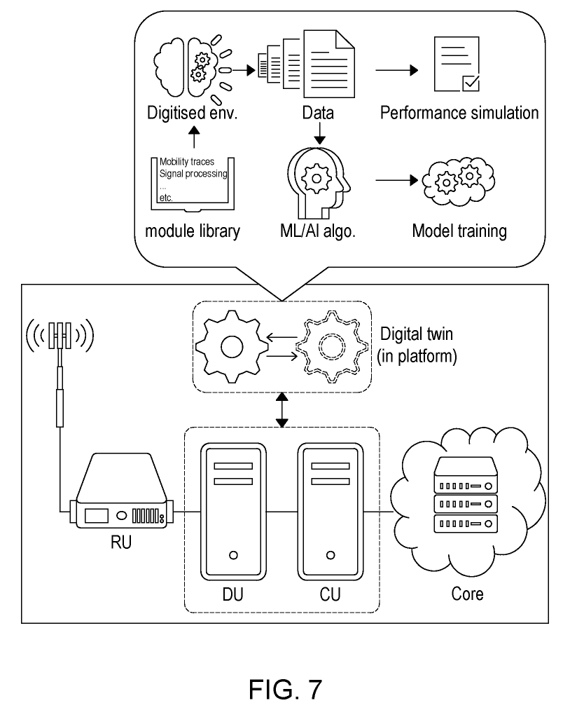

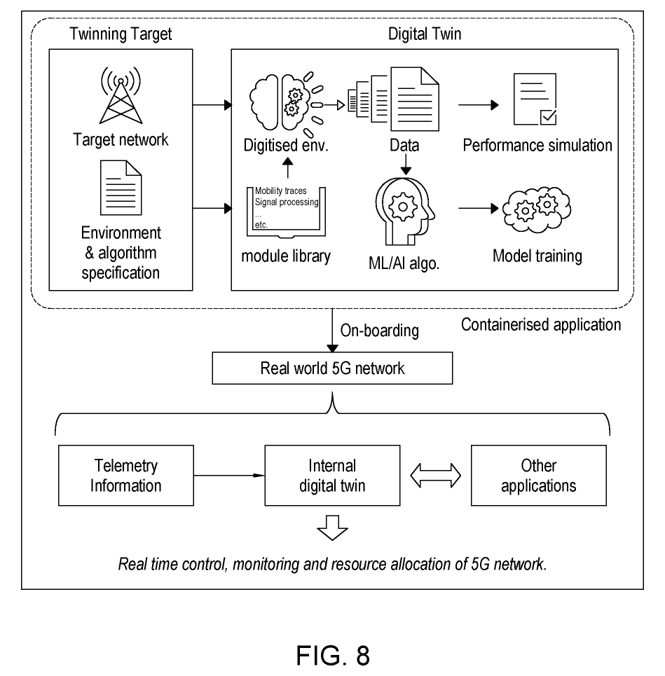

The architecture and fundamental components of the proposed digital twin framework have been detailed above. Now, the digital twin’s working from the perspective of the network/digital twin integration and implementation will be explained. As an example implementation use case, a digital twin architecture integrated in a 5G communication system is presented in FIG. 7 and FIG. 8. The functionalities of the digital twin align with the previously discussed information. The digital twin possesses the functions of performance simulation and AI/ML model development, and is deployed in the 5G system in the form of an internal application. By doing this, the digital twin can work with the real communication system closely. Due to having the digital twin functioning inside of the communication network, the telemetry information can be passed to the digital twin continuously and swiftly. Additionally, the internal digital twin can interact with other applications to improve the efficiency of information exchange. Eventually, by leveraging the communication system on-board digital twin, a real-time control, monitoring, and resource allocation scheme can be achieved.

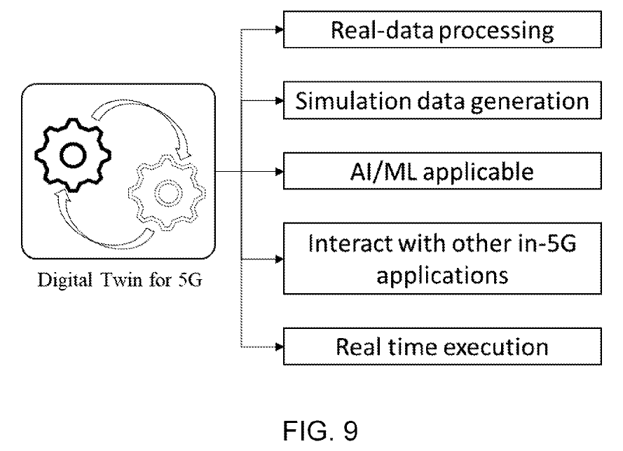

Taking the digital twin’s network internal deployment into consideration, the major functions of the digital twin implementation are demonstrated in FIG. 9. Firstly, it is able to process real-time data from the network. Secondly, the digital twin can perform simulations according to the user information, and the real data stream can play the role of the supplementary information supplier. Thirdly, this digital twin should support the AI/ML models, and the real-time data and the simulation data mentioned above can be the training and validation data of the AI/ML model. Meanwhile, a completed ML operation pipeline is also integrated in this digital twin for the model’s continuous development and continuous deployment. Fourthly, the communication system on-board digital twin can interact with other applications in the system, receiving or sharing the data. Lastly, this digital twin and the above three functions can execute in a real-time fashion, to satisfy the dynamic change of the user connections and network conditions.

On the system front, the focus of this example use case lies on the RAN. Its architecture has made significant advancements, evolving from the distributed RAN (D-RAN) and centralised ran (C-RAN) to virtualised RAN (v-RAN) and recently emerged Open RAN.

Intelligence plays a significant role in Open RAN, where the RAN Intelligent Controllers (RICs) are crucial components. RICs enhance traditional Radio Resource Management (RRM) by incorporating data-driven approaches to process the real-time telemetry of the RAN. Physically, RICs act as an interface between the RAN and the Service Management and Orchestration (SMO) layer, serving as the centralized management and control entity for the resources within Open RAN. Additionally, microservices applications, or xApps/rApps, can be implemented within RICs for the deployment of new features, services and more importantly, ML models, enabling intelligent resource control, such as automated network monitoring and analytics, traffic forecasting, and self-organisation to enhance the quality of service for users.

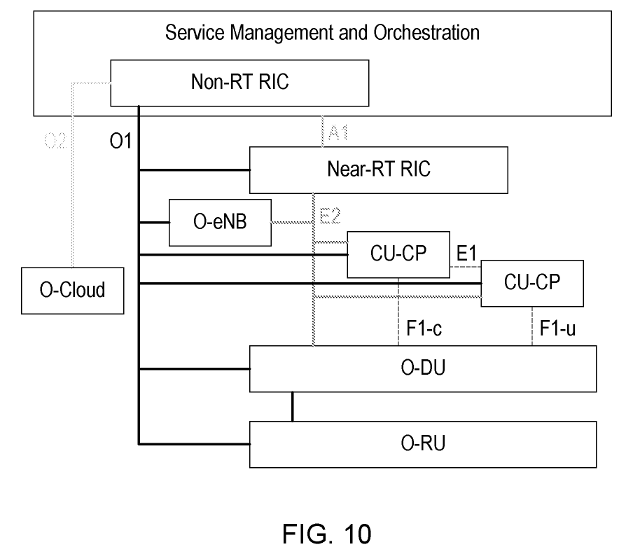

The hierarchical architecture of the Open RAN is demonstrated in FIG. 10. Open RAN adopts the 5G functional splitting defined by 3GPP, where the gNB is split into a Central Unit (CU), Distributed Unit (DU), and a Radio Unit (RU). These units are termed O-CU, O-DU, and O-RU, respectively. The O-CU is further split into two logic components, the CU control plane (CU-CP) and user plane (CU-UP) for higher deployment flexibility of different network functionalities and reducing latency, wherein the CU-CP handles the transferring commands from high-PHY in the DU to the low-PHY of the RU. The CU-UP handles the actual data traffic (I/Q samples) between RU and DU, Open RAN adopts the 7.2x split for the disaggregation of RU and DU, in which RU is responsible merely for FFT and cyclic prefix addition/removal operations, while DU performs all the remaining functionalities of the physical, Medium Access Control (MAC) and Radio Link Control (RLC) layers.

Meanwhile, the open interfaces specified in Open RAN expose telemetry and data analytics to the RICs applications for control, optimisation, and automation. In FIG. 10, the E2 interfaces connect the near-real-time (RT) RIC to the CU/DU for the near-RT control. The near-RT RIC connects with non-RT RIC through the A1 interface for the non-RT control and intelligent model updates in near-RT RIC. The O1 interface is used to link the Non-RT RIC with all other Open RAN components for management and orchestration. The O2 interface connects the Non-RT RIC and the SMO to the O-Cloud.

An example of the digital twin architecture, discussed herein, will showcase the digital twin integration and implementation scheme using the Open RAN platform, wherein the digital twin is deployed in the Open RAN as an application. This brings the benefits of the quicker response of the network states and higher controllability of the inner Open RAN network resource. Implementing this digital twin framework in Open RAN provides the following example applications.

In the realm of the 5G network, anomalies exhibit specificity in their types, stemming from diverse sources such as compromised UE-BS connections, security breaches, and service interruptions. Established anomaly detection methods encompass neural networks (NN), support vector machines, rule-based classification, statistical signal processing, and clustering. Within this digital twin, anomaly detection relies on historical records of network states and manual interventions, presenting itself as a point anomaly issue, with NN being the preferred method.

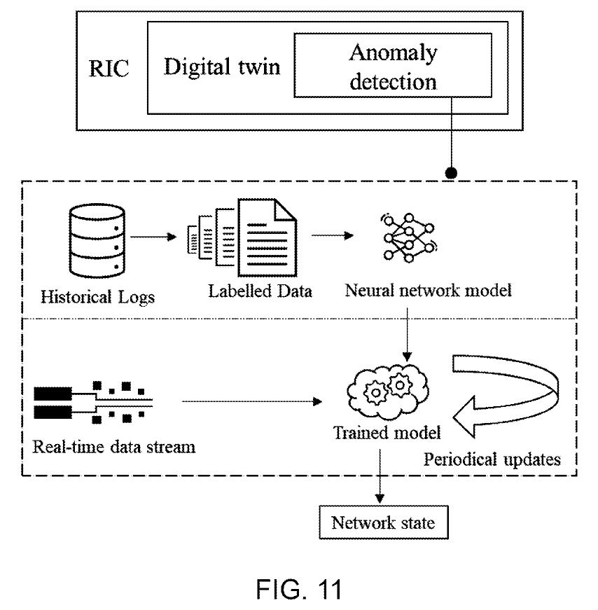

FIG. 11 illustrates a proposed workflow for anomaly detection within the digital twin, operating within the RIC of Open RAN. The workflow comprises two stages: (1) NN model generation and training, followed by deployment; and (2) application of the trained NN model for real-time prediction using data from the RIC. The trained model undergoes automatic and periodic updates to align with changes in real network anomaly patterns. In the initial stage, historical operational logs play a crucial role. Supervised learning requires labelling of logs for the NN model, while unsupervised learning eliminates this labelling process. The trained NN model eventually predicts and identifies anomalies in the real-time data stream, with the network state output serving other applications in Open RAN RICs.

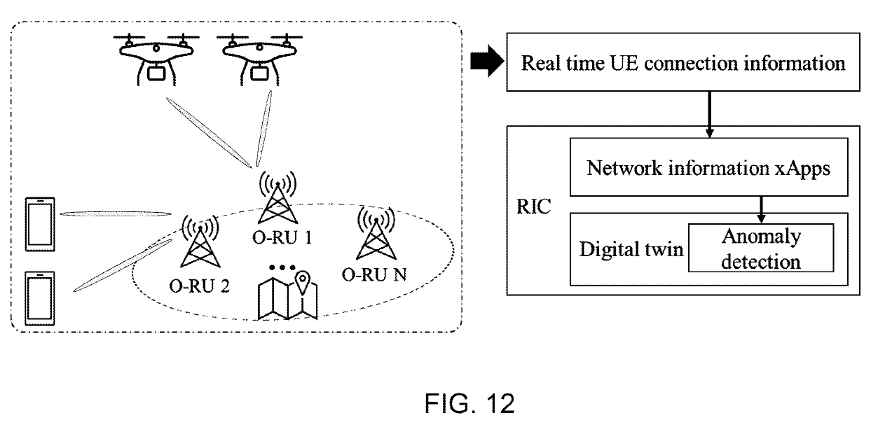

FIG. 12 elucidates the anomaly detection process within a 5G Open RAN system. Two types of UEs communicate with the O-RU geographically. On the Open RAN side, real-time UE connection information, encompassing RSRP, RSRQ, and CQI, is continuously captured by the xApp in the RIC. This information undergoes transmission to the anomaly detection module of the digital twin for real-time anomaly detection.

Another example applications lies in near-real time network throughput prediction. The throughput of a communication network is influenced by different factors. Physically, it is affected by the UE distribution, transmit power, channel condition and interference etc. Meanwhile, it is also affected by the network configuration, scheduling and slicing scheme etc. In this application, a scheduling-related simulation is the main focus. Scheduling refers to the process of allocating radio resources, such as time slots or frequency bands, to different users or services in a wireless network. 5G introduced an entirely new and flexible frame structure to better support a diverse range of devices and applications. The flexibility of the 5G frame structure lies in two aspects: time-frequency resource allocation methods, and slot and symbol-based frame design. Hence, 5G’s scheduling can be designed in a more fine-grained manner, to ensure each user or service receives a fair share of the available network resources, achieve optimal capacity utilization and improve the quality of service at different levels.

In a 5G network, scheduling decisions are made dynamically based on the current network conditions and the QoS requirements of different applications. The scheduling algorithm considers factors such as channel quality, interference, traffic load, and the priority of different applications to determine the optimal allocation of network resources. Network scheduling is important because it enables the creation of customized network services tailored to the needs of specific use cases. It also allows network operators to efficiently allocate network resources and optimize network performance.

There are many scheduling simulation packages available nowadays, for instance, the MATLAB 5G toolbox, and so it is not intended to protect any specific scheduling scheme. Instead, novelty lies in the real-time scheduling simulation based on the digital twin deployed in the Open RAN RICs. Having this real-time scheduling simulation and validation ability in digital twin is beneficial for the involved 5G Open RAN system to realise functional changes according to specific or emerging UE requirements.

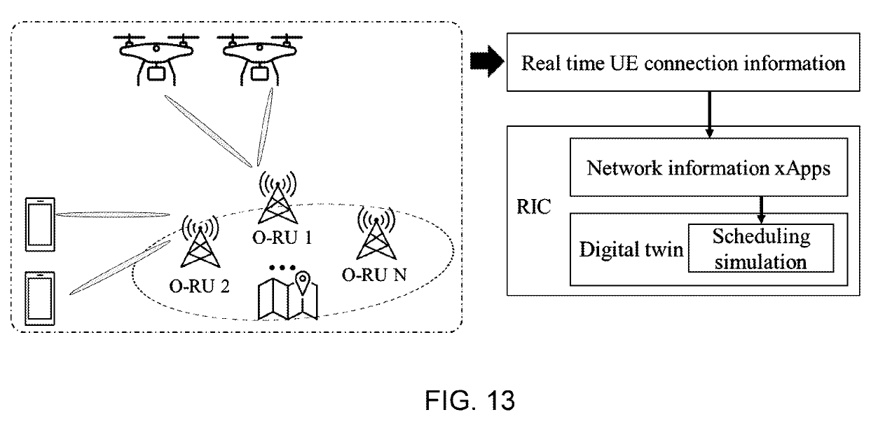

Similarly, the process of scheduling simulation in a 5G Open RAN system is shown in FIG. 13. The network operational information gathering application in the Open RAN RIC will pass the UE connectivity information such as the SINR and CQI, to this digital twin, and determine the optimal scheduling scheme based on that data. Eventually, the network scheduling parameters will be fed back into radio resource management (RRM) for scheduling determination.

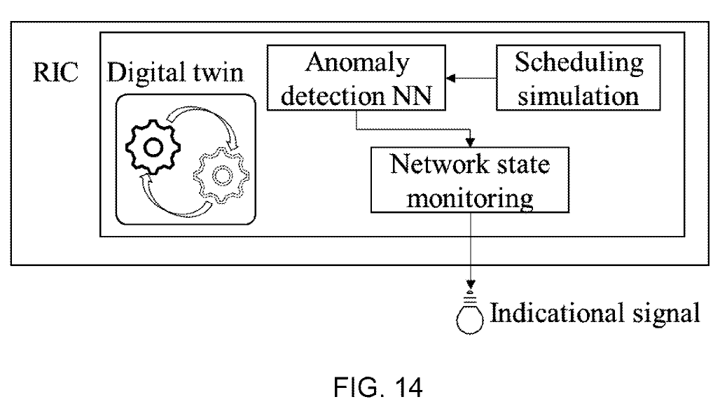

The digital twin, as a complicated software package, may contain various functions targeting different purposes. The aforementioned anomaly detection and scheduling simulation applications are representative examples. It is important to establish the necessary interaction interfaces for these applications to improve the efficiency and accuracy of the digital twin. For example, when jointly considering the applications of anomaly detection and scheduling simulation, it is clear that the scheduling simulation results can provide additional information regarding the ideal network operational states from the estimated throughput, and that could serve as a new feature in the anomaly detection NN model, as shown in FIG. 14. Finally, the indication signal of the network operational state can be used in other applications, such as network resource allocation and optimisation, energy efficient optimisation, and traffic prediction and load balancing. A more complete example of leveraging this interaction feature will be discussed later.

Advantages of the proposed digital twin system are numerous. The proposed system synthetically considers the network’s features, the digital twin’s interfaces, workflows, and functionalities, and how to match the digital twin with network for specific objectives. Meanwhile, the key features of the digital twin have been summarised as the design functions, including the AI/ML models, synthetic and real data synchronization, and the data storage and processing, etc.

Based on the above digital twin architecture, framework and design framework, an implementation example leveraging the 5G Open RAN system is conducted, which owns the following advantages.

The proposed system provides the benefits of near-real-time network performance simulation for the digital twin. Traditionally, the digital twin is treated as an external simulator package, and the twinning target can hardly communicate with the digital twin in a (near) real-time fashion. That means the response time of the digital twin is constrained by the limits of the communication process between the physical and virtual worlds. By having the digital twin deployed inside of the Open RAN, this communication cost can be decreased significantly. Especially, the Near-RT RIC of Open RAN can support up to 10ms level communication latency. Correspondingly, the deployed digital twin can serve the network simulation more swiftly, which is beneficial to the policy and response generation for the real-world network. Due to this, the operational efficiency of such a network can be improved, as the network can change the network configuration and manage the UE connectivity in a timelier manner.

Anomaly detection is another major implementation example of the proposed digital twin framework. By on-boarding the digital twin in the RIC, the anomaly detection of the 5G RAN can be conducted in a closed loop. The network’s telemetry will be sent to the digital twin for network monitor and anomaly detection. The digital twin can simulate the theoretical network performance based on the network configuration provided by the network interface. This simulation can then be used as a reference point for the actual operational status of the network, allowing for comparison and correction of performance or operational discrepancies. The digital twin can generate reference signals or performance benchmarks that help in aligning the real network’s performance with ideal or expected outcomes, enabling proactive adjustments and optimizations.

The detection result, i.e., the network operational states, can then serve other applications in this RIC. The anomaly detection application will be continuously triggered by telemetry data, and new telemetry data received after other applications take action. That offers the advantage of quick response and self-error correction for the network.

The digital twin is configured to coordinate and cooperate with other applications operating in the RAN or host platform, taking advantage of the open interfaces in the Open RAN and its data stream. Additionally, the digital twin should embrace modular design and support scalability, for better compatibility with other applications. A typical example of xApps coordination and cooperation with the digital twin is detailed later on.

Another benefit to the on-network deployment of the digital twins is the enhancement of data security. As discussed, the communication and information exchange between the twinning target and the digital twin is essential. However, in a conventional system this bi-directional communication process inevitably causes the risk of information leakage and privacy breach. For those valuable network operation information and UE telemetry, this information leakage is remarkably harmful. The proposed system seals all the involved data and processing procedures within the host platform of communication network, which avoids the information exchange between the platform and external entities. The digital twin operating and taking effect in the host platform therefore protects sensitive UE and network information from eavesdroppers.

Provided are the following three examples showing the benefits of the leveraging the digital twin applications. These examples focus on network scheduling simulations, anomaly detection, and the coordination and cooperation of different functions.

The primary requirement of the first example is that the network scheduling simulation be packed in the digital twin as one major function, and the digital twin is wrapped into the RIC in this example. This simulation tool should be a high-fidelity representation of the RAN behaviour and interaction with UEs. This example uses the MATLAB 5G toolbox for simulation. The MATLAB 5G toolbox is a software package that provides tools and functions for designing, simulating, and analysing 5G communication systems. It includes various features such as waveform generation, channel modelling, and link-level simulation. Based on this simulation toolbox, the performance of the 5G system is simulated. Specifically, when two stationary UEs are specified in the simulation and the scheduler strategy is set to ‘RR’, or ‘Round Robin’. The achieved cell downlink throughput is 88.92Mbps, which is aligned with the achievable throughput of the real-world 5G system. The on-RIC deployment strategy of this digital twin examples allows for near-real time network scheduling simulation capability.

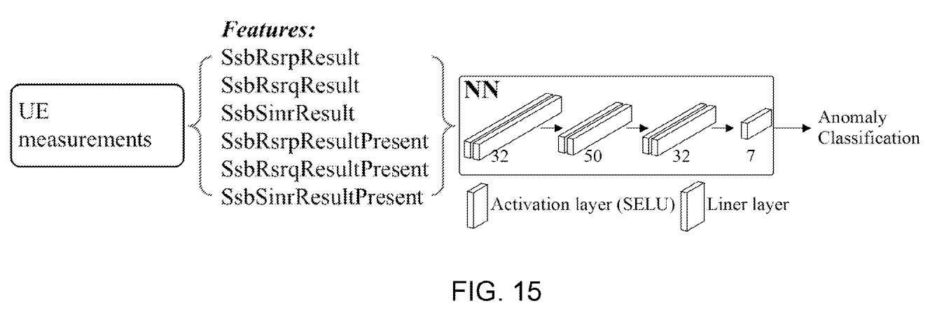

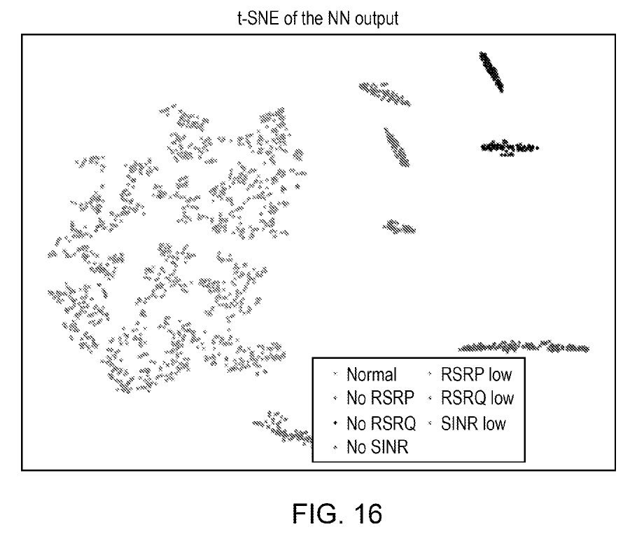

For anomaly detection, in this example, the focus is on the UE connectivity identification, i.e., the digital twin is seeking to identify a compromised UE connection using a NN model. The input features of this NN model are the corresponding UE measurements, comprising a 1x6 vector, Including the SsbRsrpResult, SsbRsrqResult, SsbSinrResult, SsbRsrpResultPresent, SsbRsrqResultPresent and SsbSinrResultPresent. A historical operational log of this network is collected and labelled in advance to train the NN model. Eventually, the NN will output a classification of the current UE connection, which could be classifying the connection as a normal connection or as one of the types of abnormal connection. The process diagram of this anomaly detection function is depicted in FIG. 15. The details of the adopted NN are also listed in this figure, which is a 4-layer fully connected NN. In this example, there are 7 connection patterns that exist, including normal connection, RSRP too low, RSRQ too low, SINR too low, no RSRP information delivered, no RSRQ information delivered, and no SINR information delivered. So the output layer of this NN contains 7 neurons. Using distributed stochastic neighbour embedding (t-SNE) on the outputs of the NN, these high-dimension outputs are visualised on the two-dimensional map, as shown in FIG. 16. This indicates that by using the NN, the connection types can be identified correctly by the digital twin.

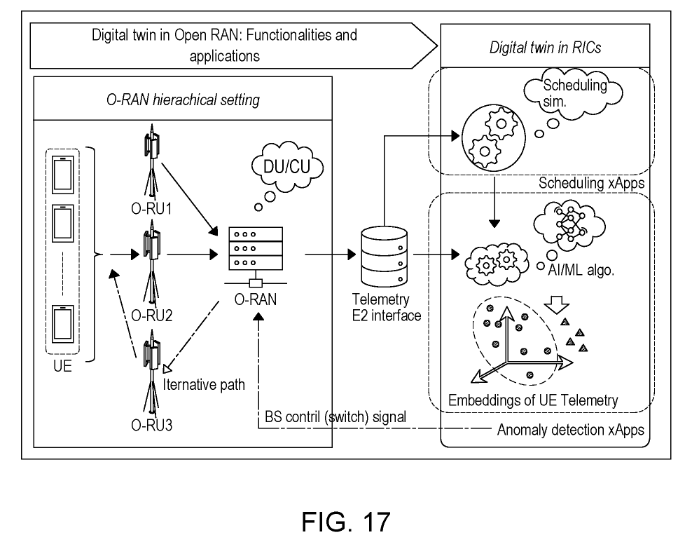

The final example demonstrates the coordination and cooperation of different functions in the digital twin for the control and resource allocation of the Open RAN. A holistic control process diagram is illustrated in FIG. 17. The ultimate objective of this example is to reset or re-connect the compromised UE to the right Base station. The left box of FIG. 17 describes the hierarchical setting of the Open RAN network, where multiple UEs are connected with different O-RU heads for network services. The UE connection information such as the Channel Quality Indicator (CQI), Reference Signal Received Power (RSRP), Reference Signal Received Quality (RSRQ), and Signal to Interference plus Noise Ratio (SINR) is passed to the digital twin deployed in the RIC. Two functions, scheduling simulation and anomaly detection, are included in the digital twin, the workflow and procedure of which are explained above. Leveraging these two functions jointly, the digital twin can identify the correctness and reliability of the built connections, wherein the scheduling simulator will estimate the theoretical overall throughput of the network connecting with UEs. This throughput information can optionally feed into the anomaly detection function for BS-UE connection identification. Eventually, this digital twin will generate a base station control signal. If the digital twin agrees that the current connection is stable and reaches the required throughput, then the connection will be fixed. Otherwise, the digital twin will send the command to switch the compromised UE connection to a new available O-RU head.

While certain arrangements have been described, they have been presented by way of example only, and are not intended to limit the scope of protection. The inventive concepts described herein may be implemented in a variety of other arrangements. In addition, various additions, omissions, substitutions and changes may be made to the arrangements described herein without departing from the scope of the invention as defined by the following claims.

1. A method performed by a computer system, the computer system serving as a host in a communications system and comprising a simulation engine, the method comprising:
receiving, from the communications system, operational information related to the communications system;
generating, using the operational information, a digital twin, the digital twin representative of the communications system;
receiving, from the communications system, network traffic data; and
simulating, using the digital twin and the network traffic data, one or more behaviours of the communications system.

2. The method of claim 1, further comprising making, based on the simulated behaviour, an adjustment to an operating parameter of the network

3. The method of claim 2, wherein the operating parameter comprises one of the following:
a resource allocation of the network;
a policy of the network; or
a configuration of the network.

4. The method of claim 1, wherein:
the computer system comprises an anomaly detection module, the anomaly detection module comprising a neural network; and
wherein simulating one or more behaviours of the communications system comprises:
inputting the network traffic data into the neural network;
determining, by the neural network, a classification of the behaviour of the network.

5. The method of claim 4, wherein determining the classification comprises classifying the behaviour as anomalous.

6. The method of claim 5, wherein:
the network traffic data comprises measurements taken by a user device; and
the behaviour of the network comprises a connection status of the user device.

7. The method of claim 6, further comprising:
responsive to classifying the behaviour as anomalous, changing a connection used by the user device.

8. The method of claim 2, wherein the digital twin comprises a scheduling module, and wherein simulating one or more behaviours of the communications system comprises simulating a throughput of the communications system in accordance with a particular traffic schedule.

9. The method of claim 8, wherein the adjustment to the operating parameter of the network comprises an adjustment to a traffic schedule of the network.

10. The method of claim 1, wherein the digital twin comprises a synthetic data generation module, and the method further comprising:
receiving, from the synthetic data generation module, synthetic network traffic data;
wherein the synthetic network traffic data is additionally used alongside the digital twin and the network traffic data to simulate one or more behaviours of the communications system.

11. The method of claim 10, further comprising:
defining, in each element of the synthetic network traffic data, a synthetic timestamp;
embedding, by a user device, a timestamp into a resource block of each element of the network traffic data; and
integrating, using the timestamps and the synthetic timestamps, the synthetic network traffic data into the network traffic data.

12. The method of claim 1, further comprising:
using a high-frequency clock synchronization protocol to match a clock speed of the digital twin with a clock speed of the communications system.

13. The method of claim 1, further comprising:
using a time analytic function to identify a time difference between the communications system and the digital twin, and applying a correction to the digital twin.

14. The method of claim 1, wherein the digital twin comprises a machine learning module, the method further comprising:
training, by the machine learning module, a machine-learning model on the operational information and network traffic data; and
deploying the trained machine-learning model in the communication network.

15. The method of claim 14, wherein the digital twin comprises a synthetic data generation module, and the method further comprising:
receiving, from the synthetic data generation module, synthetic network traffic data; and
training, by the machine learning module, the machine-learning model on the synthetic network traffic data.

16. The method of claim 1, further comprising:
receiving, from a user, a request to update the digital twin, the request comprising an indication of a characteristic of the digital twin to update, wherein the characteristic comprises at least one of:
(i) a characteristic of the communications system modelled by the digital twin;
(ii) a method of driving the simulation; and
(iii) a modelling parameter of the digital twin; and
updating the characteristic of the digital twin.

17. The method of claim 1, wherein the computer system is a distributed computer system.

18. The method of claim 13, wherein the communications system is an Open RAN network, and wherein the digital twin is comprised within the RIC of the Open RAN network.

19. A system, the system comprising:
a host platform, the host platform connected to a communication system and comprising:
a simulation engine, the simulation engine suitable for executing a simulation; and
computing hardware, the computing hardware suitable for running the simulation engine; and
a digital twin, the digital twin modelling the communication system and maintained by the simulation engine;
wherein the digital twin utilises operational information received from the communication system to improve the accuracy of the digital twin.
